(19) United States
(12) Patent Application Publication
(10) Pub. No.: US 2015/0310853 A1
(43) Pub. Date: Oct. 29, 2015

(54) SYSTEMS AND METHODS FOR SPEECH ARTIFACT COMPENSATION IN SPEECH RECOGNITION SYSTEMS

(71) Applicant: GM GLOBAL TECHNOLOGY OPERATIONS LLC, Detroit, MI (US)

(72) Inventors: CODY R. HANSEN, SHELBY TOWNSHIP, MI (US); TIMOTHY J. GROST, CLARKSTON, MI (US); UTE WINTER, PETACH TIQWA (IL)

(73) Assignee: GM GLOBAL TECHNOLOGY OPERATIONS LLC, Detroit, MI (US)

(21) Appl. No.: 14/261,650

(22) Filed: Apr. 25, 2014

(51) Int. Cl. G10L 15/08

(52) U.S. Cl. CPC G10L 15/08

(57) ABSTRACT

A method for speech recognition includes generating a speech prompt, receiving a spoken utterance from a user in response to the speech prompt, wherein the spoken utterance includes a speech artifact, and compensating for the speech artifact. Compensating for the speech artifact may include, for example, utilizing a recognition grammar that includes the speech artifact as a speech component, or modifying the spoken utterance to eliminate the speech artifact.

### TECHNICAL FIELD

The technical field generally relates to speech systems, and more particularly relates to methods and systems for improving voice recognition in the presence of speech artifacts.

### BACKGROUND

Vehicle spoken dialog systems (or “speech systems”) perform, among other things, speech recognition based on speech uttered by occupants of a vehicle. The speech utterances typically include commands that communicate with or control one or more features of the vehicle as well as other systems that are accessible by the vehicle. A speech system generates spoken commands in response to the speech utterances, and in some instances, the spoken commands are generated in response to the speech system needing further information in order to perform the speech recognition.

In many speech recognitions systems, a user is provided with a prompt generated by a speech generation system provided within the vehicle. In such systems (e.g., voice “barge-in” systems), the user may begin speaking during a prompt in situations where the system is not fast enough to stop its speech output. Accordingly, for a brief moment, both are speaking. The user may then stop speaking and then either continue or repeat what was previously said. In the latter case, the spoken utterance from the user may include a speech artifact (in this case, what is called a “stutter” effect) at the beginning of the utterance, making the user's vocal command difficult or impossible to interpret. Such errors reduce recognition accuracy and user satisfaction, and can also increase driver distraction level.

Accordingly, it is desirable to provide improved methods and systems for improving speech recognition in the presence of speech artifacts. Furthermore, other desirable features and characteristics of the present invention will become apparent from the subsequent detailed description and the appended claims, taken in conjunction with the accompanying drawings and the foregoing technical field and background.

### SUMMARY

A method for speech recognition in accordance with one embodiment includes generating a speech prompt, receiving a spoken utterance from a user in response to the speech prompt, wherein the spoken utterance includes a speech artifact, and compensating for the speech artifact.

A speech recognition system in accordance with one embodiment includes a speech generation module configured to generate a speech prompt for a user, and a speech understanding system configured to receive a spoken utterance including a speech artifact from a user in response to the speech prompt, and to compensate for the speech artifact.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a speech system in accordance with various exemplary embodiments.

FIG. 2 is a conceptual diagram illustrating a generated speech prompt and a resulting spoken utterance in accordance with various exemplary embodiments.

FIG. 3 is a conceptual diagram illustrating speech artifact compensation for a generated speech prompt and a resulting spoken utterance in accordance with various embodiments.

FIG. 4 is a conceptual diagram illustrating speech artifact compensation for a generated speech prompt and a resulting spoken utterance in accordance with various embodiments.

FIG. 5 is a conceptual diagram illustrating speech artifact compensation for a generated speech prompt and a resulting spoken utterance in accordance with various embodiments.

FIG. 6 is a conceptual diagram illustrating speech artifact compensation for a generated speech prompt and a resulting spoken utterance in accordance with various embodiments.

FIGS. 7-12 are flowcharts illustrating speech artifact compensation methods in accordance with various embodiments.

### DETAILED DESCRIPTION

The subject matter described herein generally relates to systems and methods for receiving and compensating for a spoken utterance of the type that includes a speech artifact (such as a stutter artifact) received from a user in response to a speech prompt. Compensating for the speech artifact may include, for example, utilizing a recognition grammar that includes the speech artifact as a speech component, or modifying the spoken utterance in various ways to eliminate the speech artifact.

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

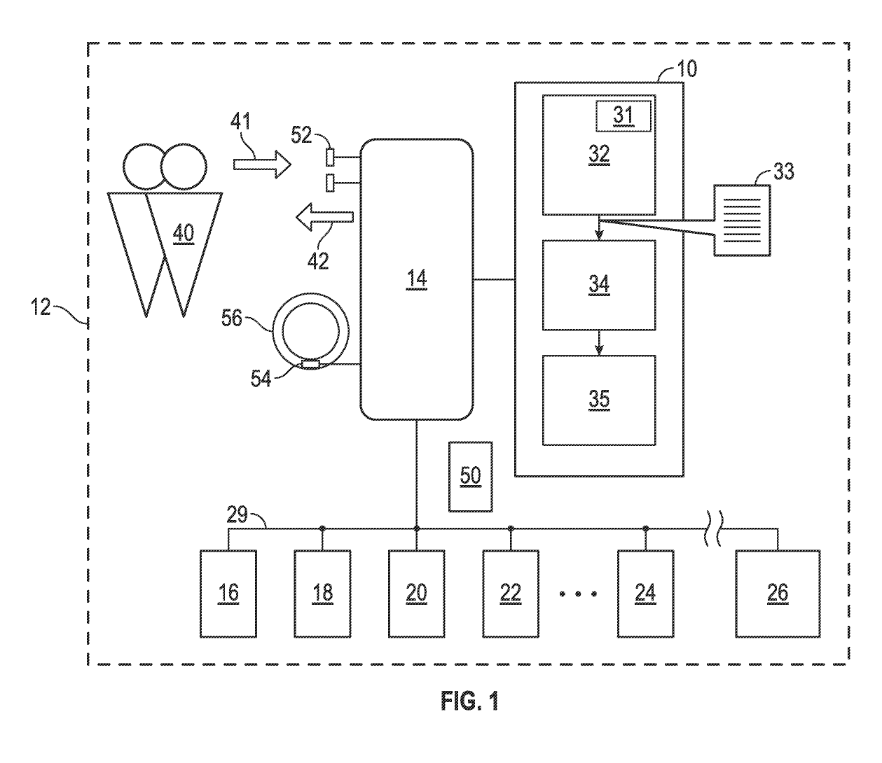

Referring now to FIG. 1, in accordance with exemplary embodiments of the subject matter described herein, a spoken dialog system (or simply “speech system”) 10 is provided within a vehicle 12. In general, speech system 10 provides speech recognition, dialog management, and speech generation for one or more vehicle systems through a human machine interface module (HMI) module 14 configured to be operated by (or otherwise interface with) one or more users 40 (e.g., a driver, passenger, etc.). Such vehicle systems may include, for example, a phone system 16, a navigation system 18, a media system 20, a telematics system 22, a network system 24, and any other vehicle system that may include a speech dependent application. In some embodiments, one or more of the vehicle systems are communicatively coupled to a network (e.g., a proprietary network, a 4G network, or the like) providing data communication with one or more back-end servers 26.

One or more mobile devices 50 might also be present within vehicle 12, including one or more smart-phones, tablet computers, feature phones, etc. Mobile device 50 may also be communicatively coupled to HMI 14 through a suitable wireless connection (e.g., Bluetooth or WiFi) such that one or more applications resident on mobile device 50 are accessible to user 40 via HMI 14. Thus, a user 40 will typically have access to applications running on at three different platforms: applications executed within the vehicle systems themselves, applications deployed on mobile device 50, and applications residing on back-end server 26. Furthermore, one or more of these applications may operate in accordance with their own respective spoken dialog systems, and thus multiple devices might be capable, to varying extents, to respond to a request spoken by user 40.

Speech system 10 communicates with the vehicle systems 14, 16, 18, 20, 22, 24, and 26 through a communication bus and/or other data communication network 29 (e.g., wired, short range wireless, or long range wireless). The communication bus may be, for example, a controller area network (CAN) bus, local interconnect network (LIN) bus, or the like. It will be appreciated that speech system 10 may be used in connection with both vehicle-based environments and non-vehicle-based environments that include one or more speech dependent applications, and the vehicle-based examples provided herein are set forth without loss of generality.

As illustrated, speech system 10 includes a speech understanding module 32, a dialog manager module 34, and a speech generation module 35. These functional modules may be implemented as separate systems or as a combined, integrated system. In general, HMI module 14 receives an acoustic signal (or “speech utterance”) 41 from user 40, which is provided to speech understanding module 32.

Speech understanding module 32 includes any combination of hardware and/or software configured to process the speech utterance from HMI module 14 (received via one or more microphones 52) using suitable speech recognition techniques, including, for example, automatic speech recognition and semantic decoding (or spoken language understanding (SLU)). Using such techniques, speech understanding module 32 generates a list (or lists) 33 of possible results from the speech utterance. In one embodiment, list 33 comprises one or more sentence hypothesis representing a probability distribution over the set of utterances that might have been spoken by user 40 (i.e., utterance 41). List 33 might, for example, take the form of an N-best list. In various embodiments, speech understanding module 32 generates list 33 using predefined possibilities stored in a datastore. For example, the predefined possibilities might be names or numbers stored in a phone book, names or addresses stored in an address book, song names, albums or artists stored in a music directory, etc. In one embodiment, speech understanding module 32 employs front-end feature extraction followed by a Hidden Markov Model (HMM) and a scoring mechanism.

Speech understanding module 32 also includes a speech artifact compensation module 31 configured to assist in improving speech recognition, as described in further detail below. In some embodiments, however, speech understanding module 32 is implemented by any of the various other modules depicted in FIG. 1.

Dialog manager module 34 includes any combination of hardware and/or software configured to manage an interaction sequence and a selection of speech prompts 42 to be spoken to the user based on list 33. When a list 33 contains more than one possible result, dialog manager module 34 uses disambiguation strategies to manage a dialog of prompts with the user 40 such that a recognized result can be determined. In accordance with exemplary embodiments, dialog manager module 34 is capable of managing dialog contexts, as described in further detail below.

Speech generation module 35 includes any combination of hardware and/or software configured to generate spoken prompts 42 to a user 40 based on the dialog determined by the dialog manager module 34. In this regard, speech generation module 35 will generally provide natural language generation (NLG) and speech synthesis, or text-to-speech (TTS).

List 33 includes one or more elements that represent a possible result. In various embodiments, each element of the list 33 includes one or more “slots” that are each associated with a slot type depending on the application. For example, if the application supports making phone calls to phonebook contacts (e.g., “Call John Doe”), then each element may include slots with slot types of a first name, a middle name, and/or a last name. In another example, if the application supports navigation (e.g., “Go to 1111 Sunshine Boulevard”), then each element may include slots with slot types of a house number, and a street name, etc. In various embodiments, the slots and the slot types may be stored in a datastore and accessed by any of the illustrated systems. Each element or slot of the list 33 is associated with a confidence score.

In addition to spoken dialog, users 40 might also interact with HMI 14 through various buttons, switches, touch-screen user interface elements, gestures (e.g., hand gestures recognized by one or more cameras provided within vehicle 12), and the like. In one embodiment, a button 54 (e.g., a “push-to-talk” button or simply “talk button”) is provided within easy reach of one or more users 40. For example, button 54 may be embedded within a steering wheel 56.

As mentioned previously, in cases where the speech system 10 generates a prompt to the user (e.g., via speech generation module 35), the user may start to speak with the expectation that the prompt will stop. If this does not happen quickly enough, the user may become irritated and temporarily stop the utterance before continuing to talk. Therefore there may be speech artifact (a “stutter”) at the beginning of the utterance followed by a pause and the actual utterance. In another scenario, the system will not stop the prompt. In such a case, most users will stop to talk after a short time, leaving an incomplete stutter artifact, and repeat the utterance only after the prompt ends. This results in two independent utterances of which the first is a stutter or incomplete utterance. Depending upon system operation, this may be treated as one utterance with a very long pause, or as two utterances.

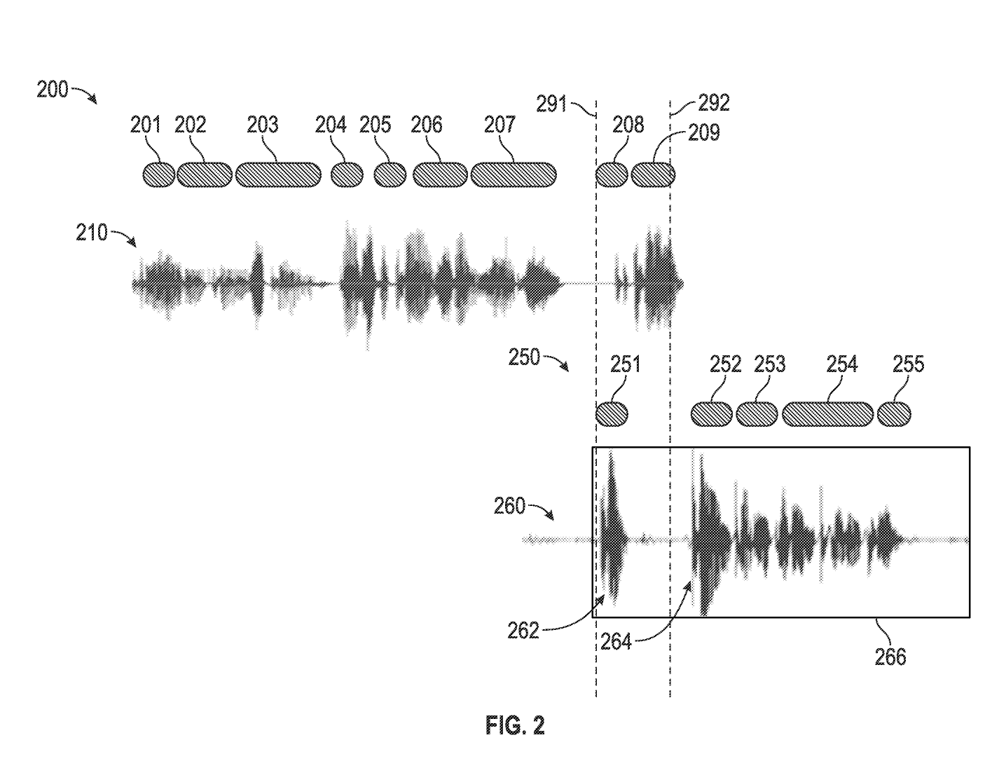

Such a case is illustrated in FIG. 2, which presents a conceptual diagram illustrating an example generated speech prompt and a spoken utterance (including a speech artifact) that might result. Specifically, a generated speech prompt dialog (or simply “prompt dialog”) 200 is illustrated as a series of spoken words 201-209 (signified by the shaded ovals), and the resulting generated speech prompt waveform (or simply “prompt waveform”) 210 is illustrated schematically below corresponding words 201-209, with the horizontal axis corresponding to time, and the vertical axis corresponding to sound intensity. Similarly, the spoken utterance from the user (in response to the prompt) is illustrated as a response dialog 250 comprising a series of spoken words 251-255 along with its associated spoken utterance waveform 260. In this regard, it will be appreciated that waveforms 210 and 260, as well as any other waveforms illustrated in the figures, are merely presented as schematic representations, and are not intended to show literal correspondence between words and sound intensity. In the interest of conciseness, items 200 and 210 may be referred to collectively simply as the “prompt”, and items 250 and 260 may be referred to as simply the “spoken utterance”.

Consider the case where prompt dialog 200 is generated in the context of the vehicle's audio system, and corresponds to the nine-word phrase “Say ‘tune’ followed by the station number . . . or name,” so that word 201 is “say”, word 202 is “tune”, word 203 is “followed”, and so on. As can be seen, the time gap between words 207 and 208 (“number” and “or”) is sufficiently long (and completes a semantically complete imperative sentence) that the user might begin the speech utterance after the word “number”, rather than waiting for the entire prompt to complete. The resulting time, which corresponds to the point in time at which the user feels permitted to speak, may be referred to as a Transition Relevance Place (TRP). For example, assume that the user wishes to respond with the phrase “tune to channel ninety-nine.” At time 291, which is mid-prompt (between words 207 and 208), the user might start the phrase by speaking all or part of the word “tune” (251), only to suddenly stop speaking when it becomes clear that the prompt is not ending. He may then start speaking again, shortly after time 292, and after hearing the final words 208-209 (“or title”). Thus, words 252-255 correspond to the desired phrase “tune to channel ninety-nine.” As mentioned previously, this scenario is often referred to as the “stutter effect,” since the entire speech utterance waveform 266 from the user includes the word “tune” twice, at words 251 and 252—i.e., “tune . . . tune to channel ninety-nine.” The repeated word is indicated in waveform 260 as reference numerals 262 (the speech artifact) and 264 (the actual start of the intended utterance). As mentioned above, currently known speech recognitions systems find it difficult or impossible to parse and interpret a spoken utterance as indicated by 266 because it includes artifact 262.

In accordance with the subject matter described herein, systems and methods are provided for receiving and compensating for a spoken utterance of the type that includes a speech artifact received from a user in response to a speech prompt. Compensating for the speech artifact may include, for example, utilizing a recognition grammar that includes the speech artifact as a speech component, or modifying the spoken utterance (e.g., a spoken utterance buffer containing the stored spoken utterance) in various ways to eliminate the speech artifact and recognize the response based on the modified spoken utterance.

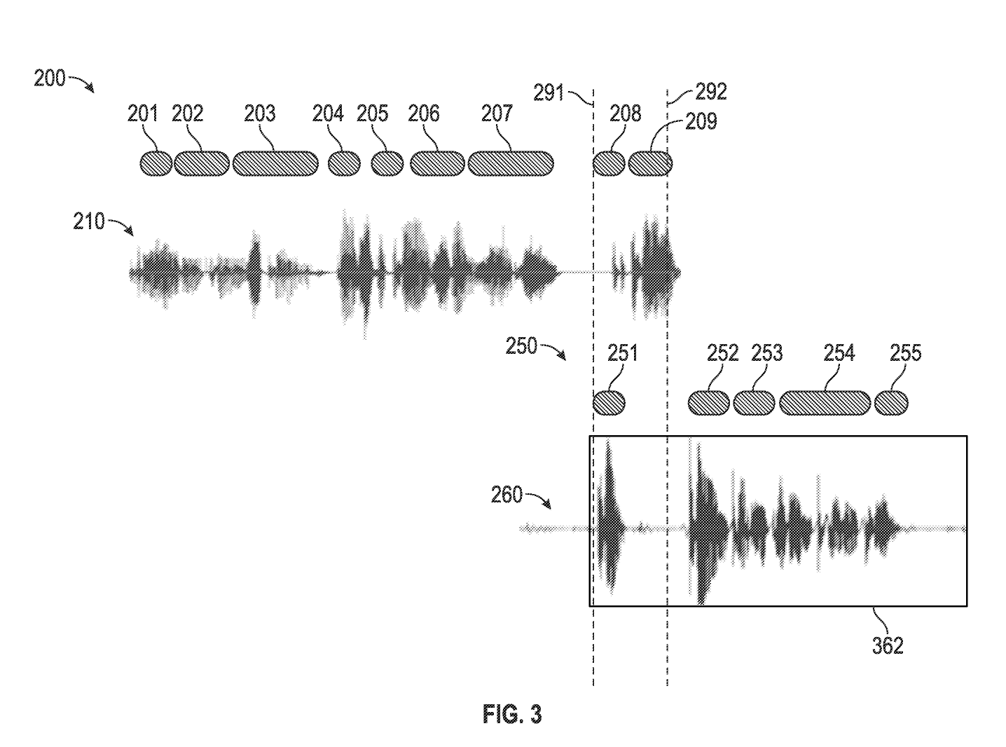

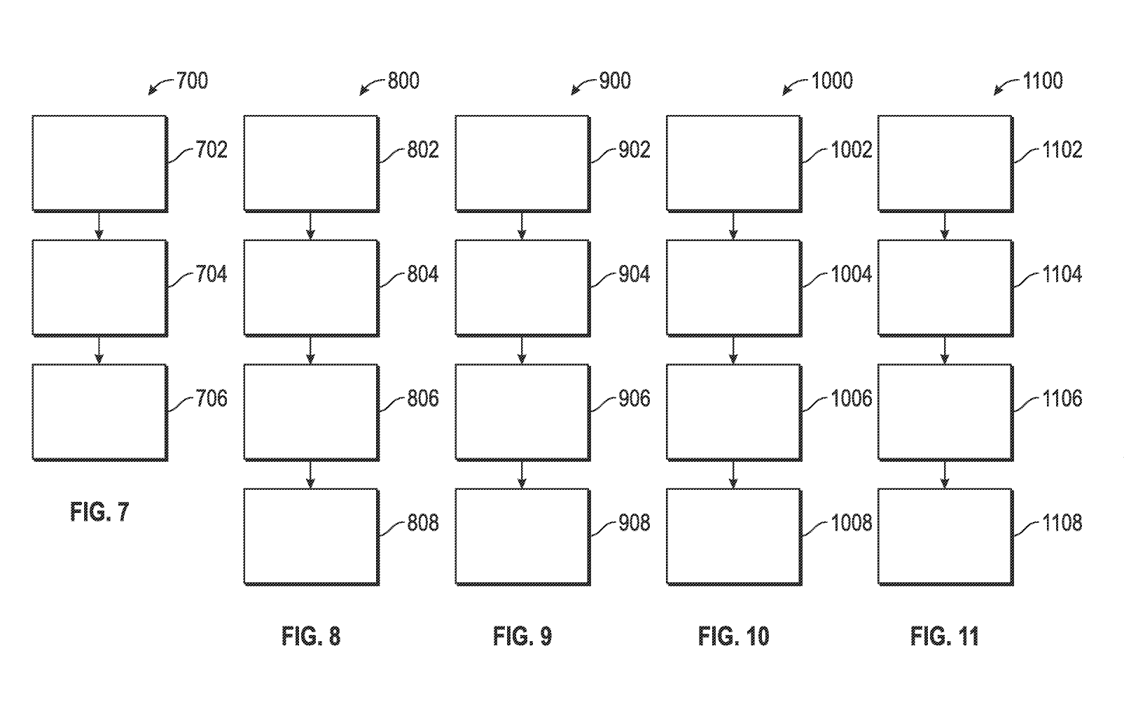

In general, and with brief reference to the flowchart shown in FIG. 7, a method 700 in accordance with various embodiments includes generating a speech prompt (702), receiving a spoken utterance from a user in response to the speech prompt, wherein the spoken utterance including a speech artifact (704), and then compensating for that speech artifact (706). In that regard, the conceptual diagrams shown in FIGS. 3-6, along with the respective flowcharts shown in FIGS. 8-11, present four exemplary embodiments for implementing the method of FIG. 7. Each of these will be described in turn.

Referring first to FIG. 3 in conjunction with the flowchart of FIG. 8, the illustrated method utilizes a recognition grammar that includes the speech artifact as a speech component. That is, the speech understanding system 32 of FIG. 1 (and/or speech artifact compensation module 31) includes the ability to understand the types of phrases that might result from the introduction of speech artifacts. This may be accomplished, for example, through the use of a statistical language model or a finite state grammar, as is known in the art.

As one example, the recognition grammar might include phonetics or otherwise be configured to understand phrases where the first word appears twice (e.g., “tune tune to channel ninety-nine”, “find find gas stations”, and the like). Thus, as depicted in FIG. 3, the resulting spoken utterance waveform 362 is considered as a whole, without removing any artifacts or otherwise modifying the waveform. Referring to FIG. 8, a method 800 in accordance with this embodiment generally includes providing a recognition grammar including a plurality of speech artifacts as speech components (802), generating a speech prompt (804), receiving a spoken utterance including a speech artifact (806), and recognizing the spoken utterance based on the recognition grammar (808). In some embodiments, the system may attempt a “first pass” without the modified grammar (i.e., the grammar that includes speech artifacts), and then make a “second pass” if it is determined that the spoken utterance could not be recognized. In another embodiment, partial words are included as part of the recognition grammar (e.g., “t”, “tu”, “tune”, etc.).

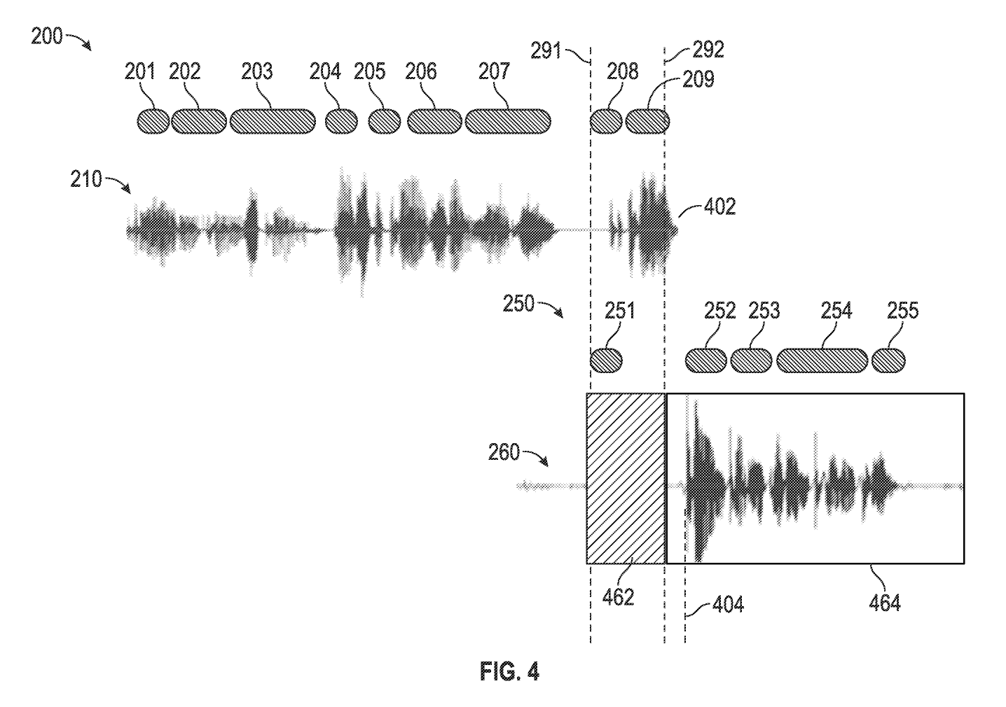

Referring to FIG. 4 in conjunction with the flowchart of FIG. 9, the illustrated method depicts one embodiment that includes modifying the spoken utterance to eliminate the speech artifact by eliminating a portion of the spoken utterance occurring prior to a predetermined time relative to termination of the speech prompt (based, for example, on the typical reaction time of a system). This is illustrated in FIG. 4 as a blanked out (eliminated) region 462 of waveform 464. Stated another way, in this embodiment the system assumes that it would have reacted after a predetermined time (e.g., 0-250 ms) after the termination (402) of waveform 210. In the illustrated embodiment, the spoken utterance is assumed to start at time 404 (occurring after a predetermined time relative to termination 402) rather than time 291, when the user actually began speaking To produce the “modified” waveform (i.e., region 464 in FIG. 4), a buffer or other memory (e.g., a buffer within module 31 of FIG. 1) containing a representation of waveform 260 (e.g., a digital representation) may be suitably modified. Referring to FIG. 9, then, a method 900 in accordance with this embodiment generally includes generating a speech prompt (902), receiving a spoken utterance including a speech artifact (904), eliminating a portion of the spoken utterance that occurred prior to a predetermined time relative to termination of the speech prompt (906), and recognizing the spoken utterance based on the altered spoken utterance.

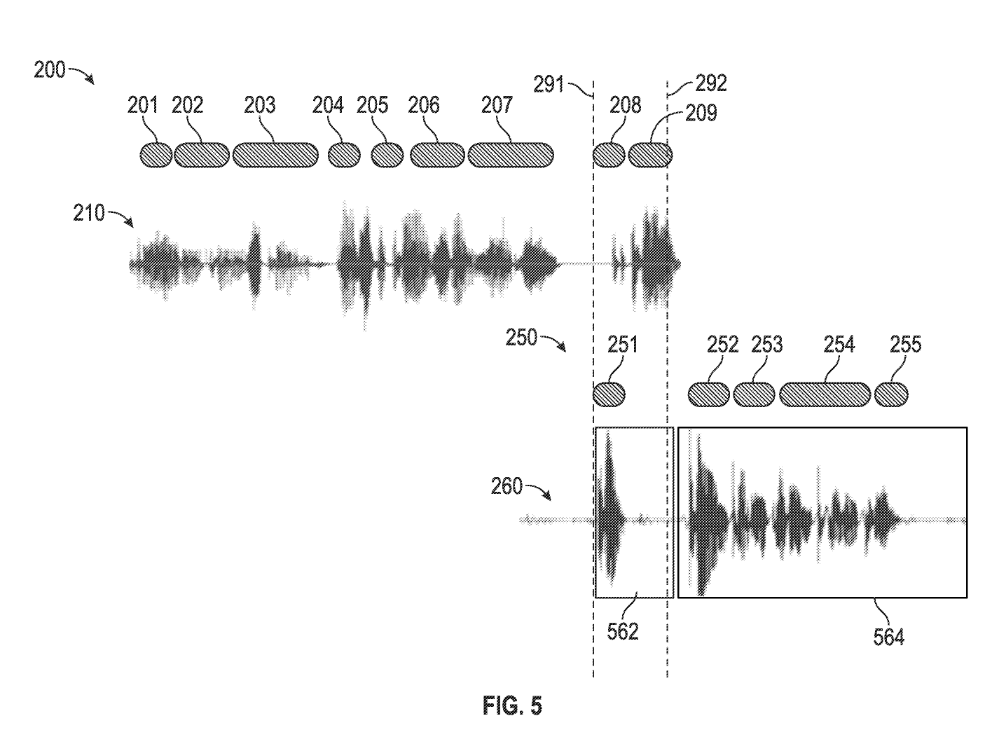

Referring to FIG. 5 in conjunction with the flowchart of FIG. 10, the illustrated method depicts another embodiment that includes modifying the spoken utterance to eliminate the speech artifact by eliminating a portion of the spoken utterance that conforms to a pattern consisting of short burst of speech followed by substantial silence. This is illustrated in FIG. 5, which shows a portion 562 of waveform 260 that includes a burst of speech (565) followed by a section of substantial silence (566). The remaining modified waveform (portion 564) would then be used for recognition. The particular model used for detecting burst patterns (e.g., burst intensity, burst length, silence duration, etc.) may be determined empirically (e.g., by testing multiple users) or in any other convenient matter. This short burst of speech followed by substantial silence would also be inconsistent with any expected commands found in the active grammar or SLM. Referring to FIG. 10, a method 1000 in accordance with this embodiment generally includes generating a speech prompt (1002), receiving a spoken utterance including a speech artifact (1004), eliminating a portion of the spoken utterance that conforms to an unexpected pattern consisting of short burst of speech followed by substantial silence (1006), and recognizing the spoken utterance based on the modified spoken utterance (1008).

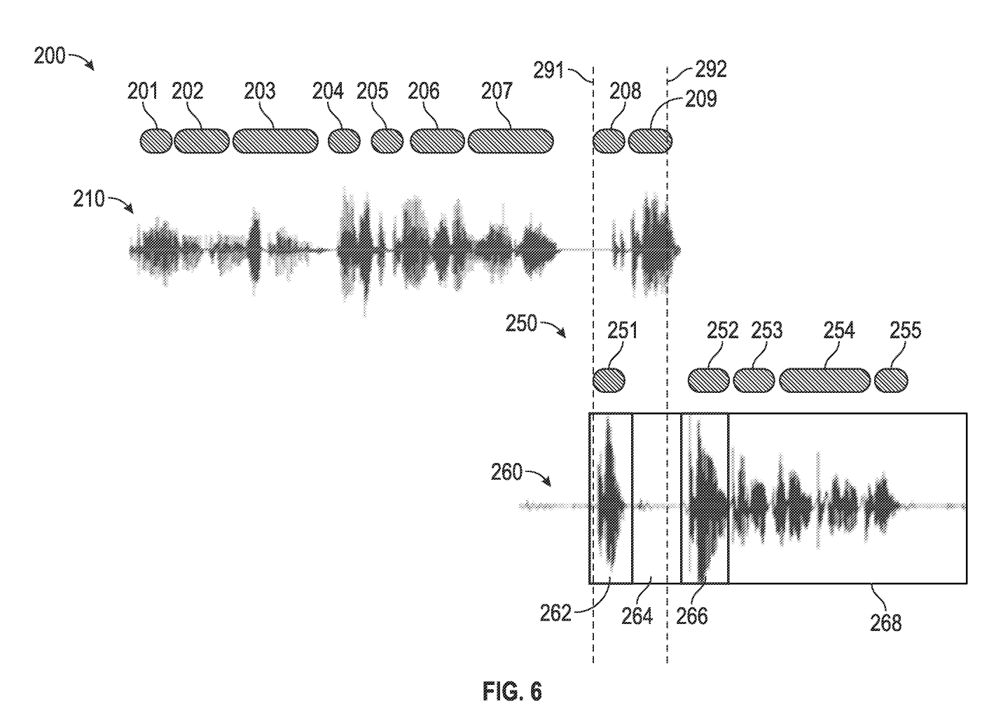

Referring now to FIG. 6 in conjunction with the flowchart of FIG. 11, the illustrated method depicts another embodiment that includes modifying the spoken utterance to eliminate the speech artifact by eliminating a portion of the spoken utterance based on a comparison of a first portion of the spoken utterance to a subsequent portion of the spoken utterance that is similar to the first portion. Stated another way, the system determines, through a suitable pattern matching algorithm and set of criteria, that a previous portion of the waveform is substantially similar to a subsequent (possibly adjacent) portion, and that the previous portion should be eliminated. This is illustrated in FIG. 6, which shows one portion 662 of waveform 260 that is substantially similar to a subsequent portion 666 (after a substantially silent region 664). Pattern matching can be performed, for example, by traditional speech recognition algorithms, which are configured to match a new acoustic sequence to multiple pre-trained acoustic sequences and determine the similarity to each of them. The most similar acoustic sequence is then the most likely. The system can, for example, look at the stutter artifact and match it against the beginning of the acoustic utterance after the pause and determine a similarity score. If the score is higher than a similarity threshold, the first part may be identified as the stutter of the second. One of the traditional approaches for speech recognition involves taking the acoustic utterance, performing feature extraction, e.g., by MFCC (Mel Frequency Cepstrum Coefficient) and sending these features through a network of HMM (Hidden Markov Models). The outcome is an n-best list of utterance sequences with similarity scores of the acoustic utterance represented by MFCC values to the utterance sequences from the HMM network

Referring to FIG. 11, a method 1100 in accordance with this embodiment generally includes generating a speech prompt (1102), receiving a spoken utterance including a speech artifact (1104), eliminating a portion of the spoken utterance based on a comparison of a first portion of the spoken utterance to a subsequent portion of the spoken utterance that is similar to the first portion (1106), and recognizing the spoken utterance based on the modified spoken utterance (1108).

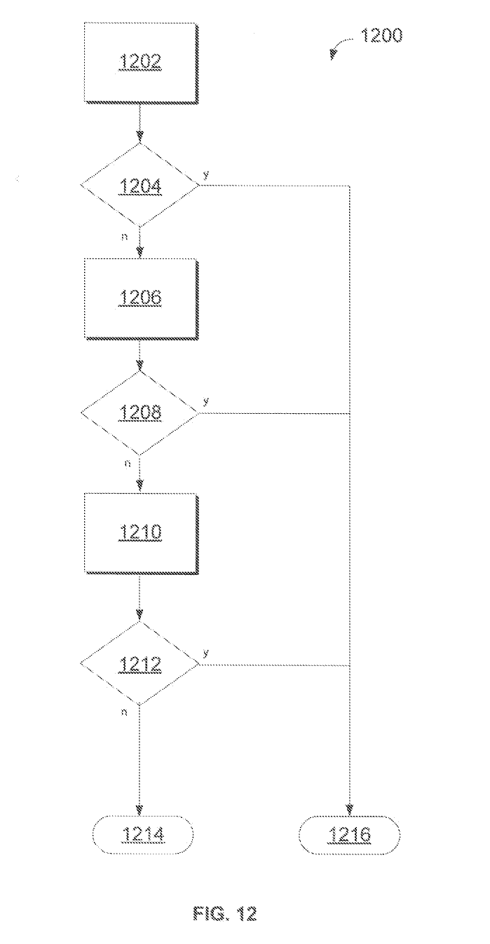

In accordance with some embodiments, two or more of the methods described above may be utilized together to compensate for speech artifacts. For example, a system might incorporate a recognition grammar that includes the speech artifact as a speech component and, if necessary, modify the spoken utterance in one or more of ways described above to eliminate the speech artifact. Referring to the flowchart depicted in FIG. 12, one such method will now be described. Initially, at 1202, the system attempts to recognize the speech utterance using a normal grammar (i.e., a grammar that is not configured to recognize artifacts). If the speech utterance is understood (‘y’ branch of decision block 1204), the process ends (1216); otherwise, at 1206, the system utilizes a grammar that is configured to recognize speech artifacts. If the speech utterance is understood with this modified grammar (‘y’ branch of decision block 1208), the system proceeds to 1216 as before; otherwise, at 1210, the system modifies the speech utterance in one or more of the ways described above. If the modified speech utterance is recognized (‘y’ branch of decision block 1212), the process ends at 1216. If the modified speech utterance is not recognized (‘n’ branch of decision block 1214), appropriate corrective action is taken. That is, the system provides additional prompts to the user or otherwise endeavors to receive a recognizable speech utterance from the user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for speech recognition comprising:
generating a speech prompt;
receiving a spoken utterance from a user in response to the speech prompt, the spoken utterance including a speech artifact; and
compensating for the speech artifact.

2. The method of claim 1, wherein the speech artifact is a stutter artifact.

3. The method of claim 1, wherein compensating for the speech artifact includes providing a recognition grammar that includes the speech artifact as a speech component.

4. The method of claim 1, wherein compensating for the speech artifact includes modifying the spoken utterance to eliminate the speech artifact.

5. The method of claim 4, wherein modifying the spoken utterance includes eliminating a portion of the spoken utterance that occurred prior to a predetermined time relative to termination of the speech prompt.

6. The method of claim 4, wherein modifying the spoken utterance includes eliminating a portion of the spoken utterance that conforms to a pattern consisting of short burst of speech followed by substantial silence.

7. The method of claim 4, wherein modifying the spoken utterance includes eliminating a portion of the spoken utterance based on a comparison of a first portion of the spoken utterance to a subsequent portion of the spoken utterance that is similar to the first portion.

8. A speech recognition system comprising:
a speech generation module configured to generate a speech prompt for a user; and
a speech understanding system configured to receive a spoken utterance from a user in response to the speech prompt, wherein the spoken utterance includes a speech artifact, and configured to compensate for the speech artifact.

9. The speech recognition system of claim 8, wherein the speech artifact is a barge-in stutter artifact.

10. The speech recognition system of claim 9, wherein the speech understanding system compensates for the speech artifact by providing a recognition grammar that includes the speech artifact as a speech component.

11. The speech recognition system of claim 8, wherein the speech understanding system compensates for the speech artifact by modifying the spoken utterance to eliminate the speech artifact.

12. The speech recognition system of claim 11, wherein modifying the spoken utterance includes eliminating a portion of the spoken utterance that occurred prior to a predetermined time relative to termination of the speech prompt.

13. The speech recognition system of claim 11, wherein modifying the spoken utterance includes eliminating a portion of the spoken utterance that conforms to a pattern consisting of short burst of speech followed by substantial silence.

14. The speech recognition system of claim 11, wherein modifying the spoken utterance includes eliminating a portion of the spoken utterance based on a comparison of a first portion of the spoken utterance to a subsequent portion of the spoken utterance that is similar to the first portion.

15. A non-transitory computer-readable medium bearing software instructions configured to cause a processor to perform the steps of:
generating a speech prompt;
receiving a spoken utterance from a user in response to the speech prompt, the spoken utterance including a speech artifact; and
compensating for the speech artifact.

16. The non-transitory computer-readable medium of claim 15, wherein compensating for the speech artifact includes providing a recognition grammar that includes the speech artifact as a speech component.

17. The non-transitory computer-readable medium of claim 15, wherein compensating for the speech artifact includes modifying the spoken utterance to eliminate the speech artifact.

18. The non-transitory computer-readable medium of claim 17, wherein modifying the spoken utterance includes eliminating a portion of the spoken utterance that occurred prior to a predetermined time relative to termination of the speech prompt.

19. The non-transitory computer-readable medium of claim 17, wherein modifying the spoken utterance includes eliminating a portion of the spoken utterance that conforms to a pattern consisting of short burst of speech followed by substantial silence.

20. The non-transitory computer-readable medium of claim 17, wherein modifying the spoken utterance includes eliminating a portion of the spoken utterance based on a comparison of a first portion of the spoken utterance to a subsequent portion of the spoken utterance that is similar to the first portion.
